(19) United States
(12) Patent Application Publication
(10) Pub. No.: US 2003/0185926 A1
(43) Pub. Date: Oct. 2, 2003

(54) Plastic net from plastic stretch film and device and method for producing the same

(76) Inventors: Harilaos Kavvadias, Crete (GR); Michail Kontojiannis, Crete (GR)

Correspondence Address: D. PETER HOCHBERG CO. L.P.A., 1940 EAST 6TH STREET, CLEVELAND, OH, 44114, US

(21) Appl. No.: 10/297,151

(22) PCT Filed: May 30, 2001
(86) PCT No.: PCT/EP01/06164

(30) Foreign Application Priority Data
Jun. 2, 2000 (DE) 100 27 527.3

(51) Int. Cl. B32B 3/10; B29C 55/06; B26F 1/26

(52) U.S. Cl. 425/363; 428/131; 264/154; 264/282; 264/288.8

(57) ABSTRACT

A plastic net consisting of a pre-stretched plastic stretch film comprises pre-stretched bridges (7) and filaments (6), said filaments extending in a main direction (5) and being transversely folded in order to increase their tensile strength. The required reshaping of the original film material is performed by a pre-stretching device (9) with interacting rollers (10, 11) and a transverse folding device (20) with a reshaping area (23) in which the width of the filaments (6) is reduced.

The invention concerns a plastic net made from plastic stretch film as well as suitable devices and procedures for the manufacture of said plastic net.

It is known to use perforated, pre-stretched plastic stretch films in the packaging of pallets, bales of hay, fruit, etc., in order to provide for sufficient extensibility and ventilation of the packaged objects. EP 820 856 A1 describes a pre-stretched plastic stretch film, in which perforations are generated by thermal irradiation procedures without contacting the film and thus with no waste film, as is produced e.g. by punching.

For other packaging purposes, it has proven more suitable to use nets that are commonly generated by braiding of or tying knots in single filaments or small strings. The extensibility of the resulting nets is limited which limits their suitability as packaging materials. Moreover, their manufacture is resource-intensive.

From WO 91/18735 A1, the use of LLDPE polyethylene film is known.

It is therefore the task of the invention to provide a plastic net that is simpler to manufacture, and a procedure as well as suitable devices for the manufacture of said plastic net.

The task is solved in the invention by a plastic net according to claim 1. Devices for manufacture of the plastic net are defined in the independent claims 7 and 11. A procedure for the manufacture of the plastic net is evident from claim 16. Advantageous further developments of the invention are defined in the dependent claims.

A plastic net according to the invention, consisting exclusively of a pre-stretched plastic stretch film, e.g. made of LLDPE polyethylene, has a multitude of perforations arranged in columns and rows, wherein a bridge is formed between each two perforations, said bridge connecting two filaments which extend in one main direction and are pre-stretched as compared to the remaining sections of the plastic stretch film.

In a particularly advantageous embodiment of the invention, the filaments of the plastic net are transversely folded transverse to the main direction, i.e. upset. Thus is generated a very large-pored net which, due to the special adhesion and extensibility properties of the plastic stretch film and the geometrical structure, is excellently suited for use as packaging or wrapping material.

In the first step of the procedure for manufacture of the plastic net according to the invention, a film strip consisting of a pre-stretched plastic stretch film is provided with perforations by locally impacting heat at each perforation. The bridges thus generated extend transverse to the main direction of the plastic stretch film and are then pre-stretched in a suitable device in order to increase the width of the film and thus its degree of utilisation. Subsequently, the filaments extending in the main direction are transversely folded in another device in order to provide the plastic net with the required strength per width unit.

A device for pre-stretching of the bridges comprises two rollers, wherein steel discs arranged on a first roller engage recesses provided in a second roller. Since the rollers contact each other, and, in a particularly advantageous embodiment, are coated with a material with a high frictional coefficient, the plastic film passing through the device can be held at the respective filaments, while the bridges are stretched, and thus pre-stretched, by the steel discs.

A device for transverse folding of the filaments according to the invention comprises two pairs of rollers between which a reshaping area is provided against which the plastic stretch film is held taut. A first section of the reshaping area comprises guide tracks over which the bridges of the plastic net can be moved in a gliding motion, whereas the filaments glide on a guide plate in the gaps between the guide tracks. In a second section, the guide tracks gradually turn into shaping ledges which gradually increase in width, while their height above the guide plate decreases. This arrangement causes the lateral filaments extending between the shaping ledges to become crimped or transversely folded. However, the filaments do not become upset in a transverse direction. Rather, the film material of each individual filament is forced to form several layers arranged one over the other, which causes the transverse folds to develop. This procedure results in the production of a thin, semi-stable filament with good longitudinal extensibility.

These and other features and advantages of the invention are illustrated in detail in the following on the basis of an example and the accompanying figures. It is shown in:

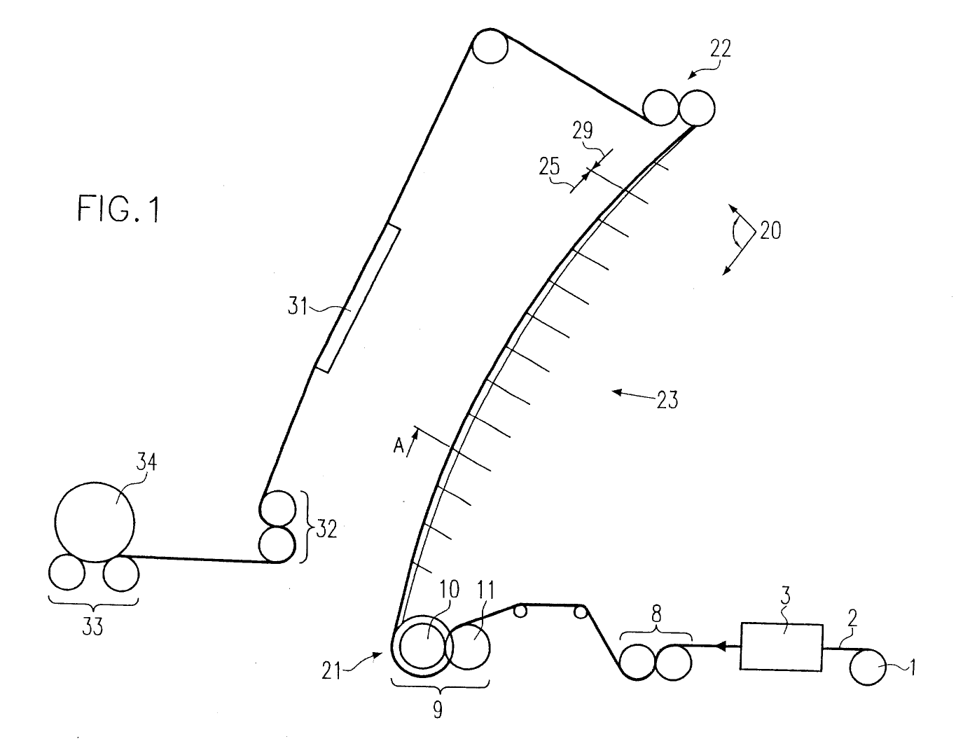

FIG. 1 a schematic side view of the entire facility for the manufacture of a plastic net according to the invention;

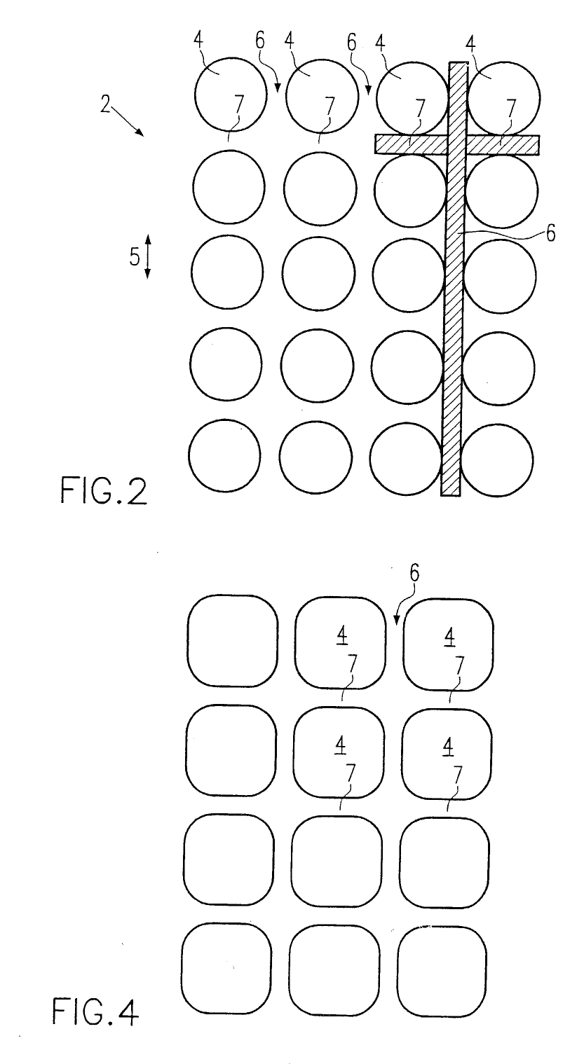

FIG. 2 a top view of a section of the plastic stretch film after generation of the perforations;

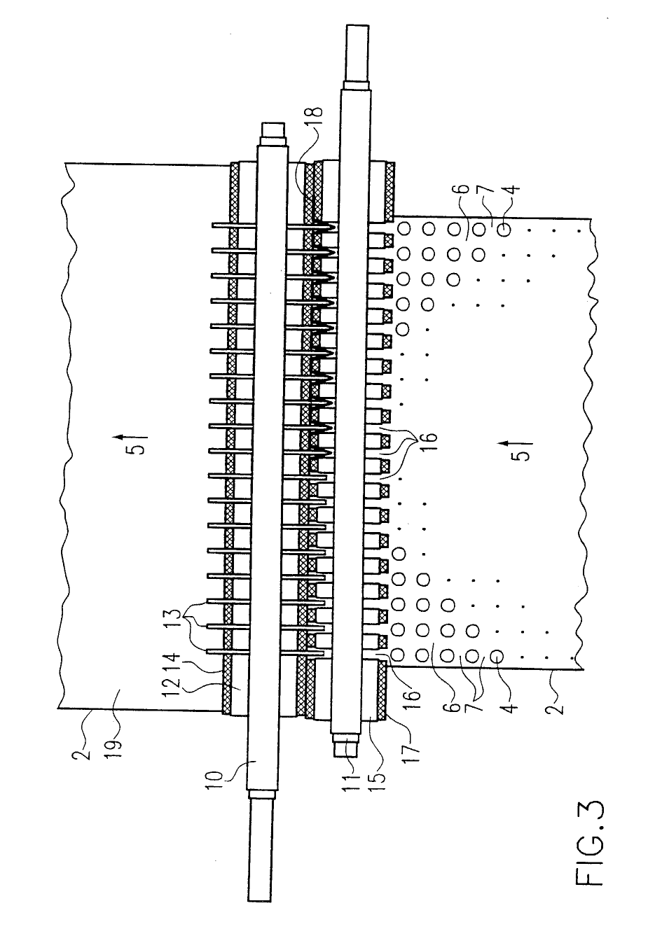

FIG. 3 a view of the device for pre-stretching of the bridges according to the invention;

FIG. 4 a top view of the plastic stretch film after pre-stretching of the bridges;

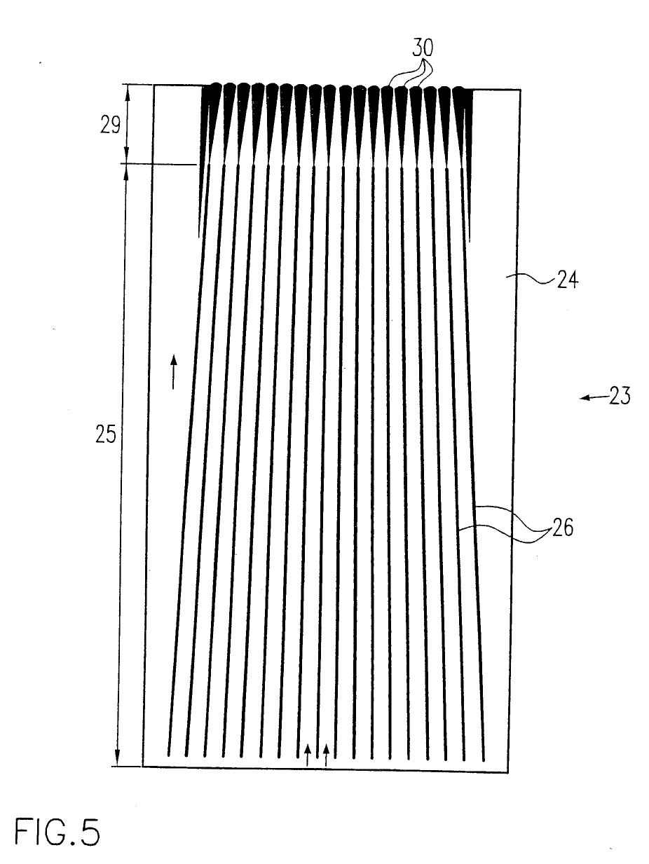

FIG. 5 a top view of a reshaping area of the device for transverse folding of the filaments according to the invention;

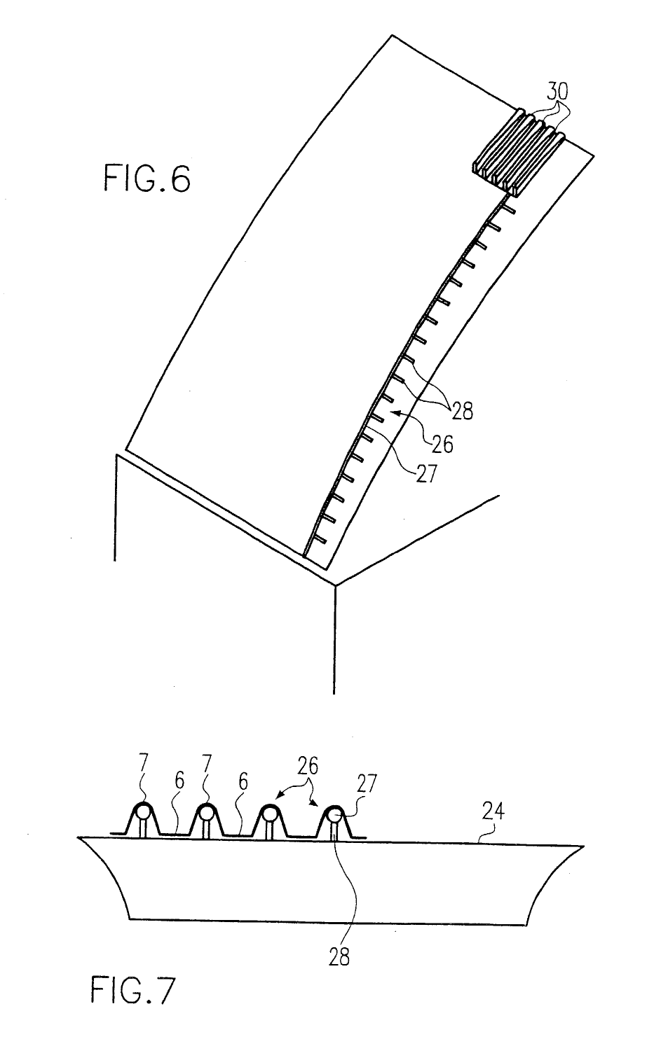

FIG. 6 a schematic perspective view of the reshaping area depicted in FIG. 5;

FIG. 7 a section through the reshaping area;

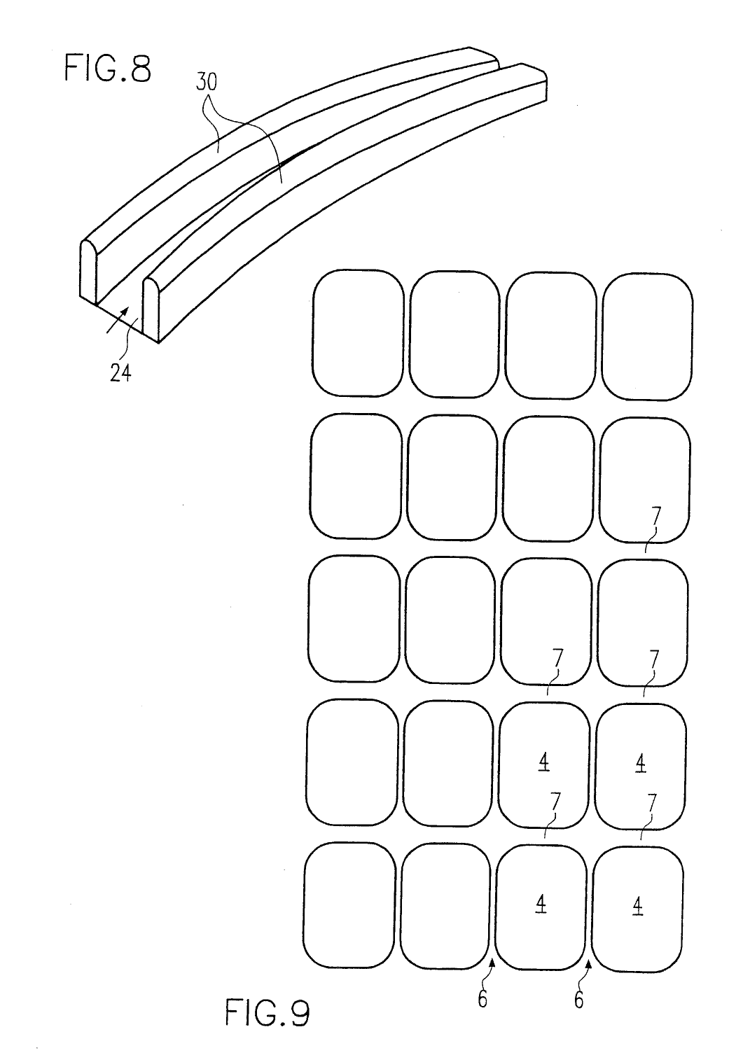

FIG. 8 an magnified view of two shaping ledges that are part of the reshaping area;

FIG. 9 a top view of a section of the final plastic net.

FIG. 1 shows a schematic side view of the entire facility for the manufacture of a plastic net according to the invention.

A broad strip of pre-stretched LLDPE (low density or very low density) polyethylene plastic stretch film 2 is continuously unwound from reservoir roll 1.

A known procedure is used to generate perforations in plastic stretch film 2 in perforation device 3. In principle, this can be facilitated by mechanical perforation of plastic stretch film 2. However, a thermal perforation procedure has proven more suitable, in which a plate with a multitude of tips heated to a minimum of 500° C. is applied to the film. As soon as the tips contact plastic stretch film 2, perforations are generated at the contacted sites of the film, each perforation possessing a build-up at its perimeter whose thickness exceeds that of the rest of plastic stretch film 2. Due to the accumulation of material at each perforation, plastic stretch film 2 can be stretched further without tearing in subsequent procedural steps.

FIG. 2 shows a top view of a section of plastic stretch film 2 after it exits perforation device 3.

Accordingly, perforations 4 are arranged in columns extending along a main direction 5 and in rows extending transverse to main direction 5. With regard to the specific material of plastic stretch film 2 it shall be defined that the strips of the material extending in main direction 5 shall be considered as filaments 6, whereas the parts of the material extending transverse to main direction 5 and connecting filaments 6 shall be called bridges 7. It is evident from FIG. 2 that the transition between filaments 6 and bridges 7 is continuous. For illustration of the term, “filament”, a hatched area is shown in the figure adjoining two other hatched areas indicating bridges 7.

The definition of filaments 6 and bridges 7 as sub-areas of plastic stretch film 2 is made for the purpose, in addition to other purposes, of illustrating the invention in the following.

Once it exits perforation device 3, plastic stretch film 2 is guided through a generally known longitudinal stretching facility 8 comprising a pair of rollers.

Subsequently, plastic stretch film 2 is guided to a device for pre-stretching of bridges 7 according to the invention (hereinafter denoted as pre-stretching device 9).

Pre-stretching device 9 shown as a top view in FIG. 3 comprises a first roller 10 and a second roller 11.

Roll bodies 12 and steel discs 13 are provided on first roller 10. Roll bodies 12 and steel discs 13 can be connected to each other as being one piece or may be slipped onto first roller 10 as separate elements.

The number of steel discs 13 corresponds to the number of perforations 4 in each transverse row of plastic stretch film 2. Therefore, the distance of steel discs 13 corresponds exactly to the corresponding distance of perforations 4 in transverse direction.

The radial external sides of roll bodies 12 is coated with rubber.

Second roller 11 also comprises roll bodies 15 attached to second roller 11 either as separate elements or in one piece. Roll bodies 15 form recesses 16, the number of which corresponds to the number of steel discs 13.

The radial external areas of roll bodies 15 are also coated by rubber layers 17.

It is evident from FIG. 3 that first roller 10 and second roller 11 are in a relative arrangement such that their rubber layers 14, 17, and thus their roll bodies 12, 15, contact each other and can roll against each other. This arrangement allows steel discs 13 to engage the corresponding recesses 16.

FIG. 3 also shows a schematic top view of the approaching strip of plastic stretch film 2, as is shown in FIG. 1. Plastic stretch film 2 is guided through between first roller 10 and second roller 11 such that the filaments are being held by rubber layers 14, 17, whereas perforations 4 and bridges 7 in between perforations 4 initially come to reside above recesses 16. Upon further rotation of rollers 10, 11, perforations 4 and bridges 7 are transported into the impact area of steel discs 13 and are pressed deep into recesses 16 as is shown by the deformed plastic stretch film 18 in FIG. 3.

This causes bridges 7 to become stretched, which substantially increases the total width of the strip of plastic stretch film 2. As an example, it is possible to stretch a strip with an original width of 50 cm to a strip with a width of 80 cm. The effect of the increase in width is shown schematically in FIG. 3 by strip 19 of plastic stretch film 2 being wider.

After plastic stretch film 2 has been stretched in longitudinal and transverse direction in longitudinal stretching device 8 and pre-stretching device 9, respectively, the shape of perforations 4, filaments 6, and bridges 7 changed as is shown in the top view of plastic stretch film 2 in FIG. 4.

Immediately after exiting pre-stretching device 9, plastic stretch film 2 is guided to a device for transverse folding of filaments 6 according to the invention (hereinafter denoted as transverse folding device 20).

Alternatively, plastic stretch film 2 can also be used as a final product as it comprises a net even at this stage. In this case, plastic stretch film 2 exiting pre-stretching device 9 is directly guided through transport and stretching rollers to heating facility 31, to be described below, for reeling onto a roll without transverse folding of filaments 6. This “intermediate product” is a suitable final product as it possesses good properties for use as a plastic net. Compared to the actual final product generated by completing the entire procedure, it offers as an advantage its larger film width of for instance 75-80 cm.

Transverse folding device 20 comprises a first pair of rollers 21, a second pair of roller 22, and a reshaping area 23 arranged between the pairs of roller, 21, 22.

In the embodiment of the invention shown in FIG. 1, the first pair of rollers 21 is implemented by pre-stretching device 9. However, since transverse folding device 20 can be operated as well without pre-stretching device 9, the specific effects of pre-stretching device 9 are not indispensable. A common pair of rollers can be used for transverse folding device 20 to substitute for pre-stretching device 9.

The first and second pair of rollers, 21, 22, are capable of tautening—and possibly stretching—plastic stretch film 2 and pressing it against reshaping area 23 which has a curved shape with respect to main direction 5, i.e. the direction in which plastic stretch film 2 is moved.

Reshaping area 23 is illustrated in detail in FIG. 1 and FIGS. 5 through 8 with FIG. 1 showing a side view of reshaping area 23, FIG. 5 showing a top view of reshaping area 23 (seen from the left in FIG. 1), and FIG. 6 showing a perspective view of reshaping area 23.

Reshaping area 23 comprises a curved guide plate 24 over which plastic stretch film 2 is guided.

A number of guide tracks 26, the number of which corresponds to the number of bridges 7 in transverse direction, is arranged in a first section 25 of guide plate 24, which may be implemented by a curved sheet of metal. The distance of guide tracks 26 decreases along the extension of first section 25, as is shown in FIG. 5.

FIG. 7 shows a schematic section of reshaping area 23 in the direction of arrow A in FIG. 1. Accordingly, each guide track 26 is implemented by an elongated tube 27 that is held on guide plate 24 by means of supports 28.

First section 25 turns into second section 29, in which guide tracks 26 turn into shaping ledges 30.

FIG. 8 shows an enlarged view of shaping ledges 30. The height with respect to guide plate 24 of the initial area of each shaping ledge 30 near first section 25 is greater than the width of shaping ledge 30. The height decreases along the extension of second section 29 and shaping ledge 30, whereas the width increases until ultimately at the end of second section 29 in the vicinity of second pair of rollers 22, the height of shaping ledge 30 becomes smaller than its width. The gap between shaping ledges 30 decreases accordingly, as is shown in FIGS. 5 and 8.

Depending on the specific requirements, wedge-shaped shaping ledges 30 may be made from a tube-like or massive material and then attached to guide plate 24.

The function of transverse folding device 20 is explained in the following.

As mentioned earlier, plastic stretch film 2 is pressed taut against guide plate 24 by means of two pairs of rollers 22, 23. In this arrangement, plastic stretch film 2 proceeds over guide tracks 26 such that filaments 6 reside in the gaps between guide tracks 26, i.e. in contact with guide plate 24, whereas bridges 7 arch over guide tracks 26, as is also evident from FIG. 7.

Since guide tracks 26 continue to approach each other in the further course, filaments 6 become pushed together ultimately leading to the formation of folds extending in longitudinal direction (main direction 5). Because of the lateral folding effect, this process is called transverse folding.

The folding effect is enhanced by shaping ledges 30 after plastic stretch film 2 comes off guide tracks 26. Bridges 7 of plastic stretch film 2 are guided over the respective backs of shaping ledges 30, whereas filaments 6 in the gaps of the shaping ledges are folded together to an increasing degree. As an example, a filament 6 entering second section 29, i.e. at the beginning of shaping ledge 30, has a width of approx. 16 mm that is reduced to only 2 mm when the filament exits the second section, i.e. just ahead of second pair of rollers 22. The good adhesion of the material of plastic stretch film 2 provides for easy crimping of filament 6.

Second pair of rollers 22 serves not only for keeping plastic stretch film 2 taut and stretching it, but also as a pinching roller to stabilise folded filaments 6.

After it exits second pair of rollers 22, the plastic net meanwhile generated from plastic stretch film 2 is guided over heating facility 31 (approx. 80° C.) to level out any tensions and for normalisation or stabilisation, and subsequently stretched again in a stretching facility 32 comprising two rollers, before it is reeled in reeling facility 33 to form roll 34.

At the end of the procedure, the plastic net has the structure shown in FIG. 9, i.e. with stretched bridges 7 and folded filaments 6. Due to the accumulation of material during the transverse folding process, the stability of filaments 6 is very high, which provides for very high stability of the plastic net.

The properties of the plastic net can be influenced in numerous ways by the selection of material strength and net structure, the latter being subject to the choice of parameters in the procedure described above, and especially through the so-called “memory effect”. The “memory effect” causes the stretch material to tightly wrap around the packaged object once the object is wrapped in the plastic net to the effect that the plastic net adheres tightly to the object. This makes it easy to wrap the outer circumference of bales of straw or hay with the net material such that it protrudes some ways beyond the limits of the object and constricts sufficiently for not only the outer circumference, but also the faces of the object to become wrapped (approx. 10 cm width) without having to change the direction of wrapping. This means that the bales become encased in the plastic net on all sides without having either the bale or the wrapping device having to be rotated during wrapping. A similar effect is otherwise known from shrink tubes only, but these would be unsuited for use with bales of hay.

1. Plastic net consisting of a pre-stretched plastic stretch film (2) provided with
a multitude of perforations (4) in the plastic stretch film (2) arranged in columns along a main direction and rows transverse to the main direction;
bridges (7) between two perforations (4), said bridges (7) consisting of the plastic stretch film (2) and extending transverse to the main direction (5);
filaments (6) between two perforations (4), said filaments (6) consisting of the plastic stretch film (2) and extending in the main direction (5); wherein
the bridges (7) are pre-stretched in a direction transverse to the main direction (5);
characterised in that the filaments (6) consist of sub-areas of the plastic stretch film (2) that are transversely folded with respect to the main direction.

2. Plastic net according to claim 1, characterised in that the perforations (4) in the plastic stretch film (2) are generated by a thermal procedure.

3. Plastic net according to claim 2, characterised in that the perforations (4), after their generation and before further processing, are surrounded by a build-up with a greater thickness than that of the plastic stretch film, such that material accumulates around each perforation.

4. Plastic net according to anyone of the claims 1 through 3, characterised in that the plastic stretch film (2) consists of LLDPE polyethylene.

5. Device (9) for the manufacture of a plastic net, for continuous pre-stretching of sub-areas of a plastic stretch film (2) travelling through the device, said sub-areas extending in a main direction (5) and being pre-stretched in a direction transverse to the main direction (5), comprising a first roller (10) and a second roller (11) in a parallel arrangement with respect to the first roller (10), wherein
the first roller (10) comprises at least as many steel discs (13) as there are sub-areas and the distance between steel discs corresponds to the distance of the sub-areas;
the second roller (11) comprises as many ring-shaped recesses (16) as there are steel discs (13) and the distance between ring-shaped recesses (16) corresponds to the distance of the steel discs (13);
the first roller (10) and the second roller (11) are arranged at a distance such that each steel disc (13) of the first roller (10) engages a recess (16) of the second roller (11); and wherein
the plastic stretch film (2) can be guided between the two rollers (10, 11) such that each sub-area to be pre-stretched can be guided tangentially between a steel disc (13) and a corresponding recess (16);
characterised in that
the roller areas (12) of the first roller (10) adjacent to the steel discs (13) are coated with a material (14) with a high frictional coefficient, and/or in that
the roller areas (15) of the second roller (11) adjacent to the ring-shaped recesses (16) are coated with a material (17) with a high frictional coefficient.

6. Device according to claim 5, characterised in that the respective roller areas (12, 15) of the first (10) and the second roller (11) are coated with the material (14, 17) and arranged such that the roller areas (12, 15) coated with the materials (14, 17) contact each other and roll off on each other.

7. Device (20) for the manufacture of a plastic net, for continuous transverse folding of filaments (6), extending in a main direction (5), of a plastic stretch film (2) which travels through the device and comprises a multitude of perforations (4) arranged in rows and in columns along the main direction (5), comprising
a first (21) and a second pair of rollers (22) which transport the plastic stretch film (2) in the main direction (5) and hold it taut; and
a curved reshaping area (23) arranged between the first and the second pair of rollers (21, 22);
wherein
the first and the second pair of rollers (21, 22) and the reshaping area (23) are in a relative spatial arrangement such that the plastic stretch film (2) can be held taut against the reshaping area (23);
the reshaping area (23) comprises a guide plate (24) which is curved in the main direction (5);
a first section (25) of the guide plate (24) is provided with several guide tracks (26) extending essentially in the main direction (5);
a second section (29) of the guide plate (24) is provided with several shaping ledges (30) each being an extension of the guide tracks (26);
in an initial section near the first section (25), the height of each shaping ledge (30) relative to the guide plate (24) is greater than the width of each shaping ledge (30), and wherein the height continually decreases along the extension of second section (29) in the direction of the second pair of rollers (22) such that in the vicinity of the second pair of rollers (22) the height of the shaping ledge (30) is smaller than its width.

8. Device according to claim 7, characterised in that the distance of the guide tracks (26) decreases along the extension of the first section (25).

9. Device according to claim 7 or 8, characterised in that each guide track (26) Is provided by several supports (28) that attached to the guide plate (24) and bear a guide body (27).

10. Device according to claim 9, characterised in that the guide body (27) can be manufactured from a tube-shaped material.

11. Device according to anyone of the claims 7 through 10, characterised in that the plastic stretch film (2) can be guided over the reshaping area (23) such that the filaments (6) glide over the guide plate (24) and the bridges (7) connecting the filaments (6) glide over the guide tracks (26) and the shaping ledges (30).

12. Procedure for the manufacture of a plastic net (2) according to anyone of the claims 1 through 4 comprising the steps of
providing a strip of film of a pre-stretched plastic stretch film (2);
generating perforations (4) in the plastic stretch film (2) by local heat treatment to produce each perforation (4);
pre-stretching of the bridges (7),
transverse folding of the filaments (6).

13. Procedure according to claim 12, characterised by the subsequent steps of
crimping the transversely folded filaments (6) with a pair of crimping rollers (22);
guiding the plastic stretch film (2) over a heating facility (31).

14. Procedure according to claim 12 or 13, characterised in that the plastic stretch film (2) is stretched in the main direction after the perforations (4) are generated and before the bridges (7) are pre-stretched.
